(19) United States
(12) Patent Application Publication
(10) Pub. No.: US 2026/0204767 A1
(43) Pub. Date: Jul. 16, 2026

(54) ELECTRONIC DEVICE

(71) Applicant: PEGATRON CORPORATION, TAIPEI CITY (TW)

(72) Inventors: Cheng-Hsiung Wu, Taipei City (TW); Chih-Wei Liao, Taipei City (TW); Chia-Hung Chen, Taipei City (TW); Chao-Hsu Wu, Taipei City (TW); Hau Yuen Tan, Taipei City (TW); Chih-Chien Hsieh, Taipei City (TW)

(73) Assignee: PEGATRON CORPORATION, TAIPEI CITY (TW)

(21) Appl. No.: 19/363,745

(22) Filed: Oct. 21, 2025

(30) Foreign Application Priority Data
Jan. 10, 2025 (TW) 114101087

(51) Int. Cl. H01Q 1/22; H01Q 1/02; H01Q 5/20; H01Q 5/30

(52) U.S. Cl. CPC H01Q 1/2266; H01Q 1/02; H01Q 5/20; H01Q 5/30

(57) ABSTRACT

An electronic device, including a first body including first and second metallic enclosures, a metal assembly and an antenna. The second metallic enclosure is arranged at the first metallic enclosure. An internal space is formed between the first and second metallic enclosures. The metal assembly is disposed in the internal space. The metal assembly is connected to the first and second metallic enclosures, and forms a metal cavity together with the first and second metallic enclosures. The metal cavity has an opening opposite to the metal assembly. The antenna is disposed in the metal cavity and close to the opening, and includes a grounded radiator, a radiator assembly and a low frequency feed arm. The grounded radiator is conducted to the first metallic enclosure. A ground end of the radiator assembly is connected to the ground radiator. The low frequency feed arm is connected to the radiator assembly.

### CROSS-REFERENCE TO RELATED APPLICATION

This application claims the priority benefit of Taiwan application serial no. 114101087, filed on January 10, 2025. The entirety of the above-mentioned patent application is hereby incorporated by reference herein and made a part of this specification.

### BACKGROUND

### Technical Field

The disclosure relates to an electronic device, and more particularly to an electronic device having an antenna.

### Description of Related Art

With the advancement of technology, a demand for disposing antennas in electronic devices has increased. In addition, since the shells of current electronic devices are often designed as metal to provide a better appearance texture, an antenna performance is easily affected by the metallic enclosure. Therefore, how to dispose an antenna in a metallic enclosure to achieve good antenna characteristics is a direction of research in the art.

### SUMMARY

The disclosure provides an electronic device, in which an antenna is disposed inside a metallic enclosure, and good antenna characteristics can be achieved.

An electronic device of the disclosure includes a first body. The first body includes a first metallic enclosure, a second metallic enclosure, at least one metal assembly, and at least one antenna. The second metallic enclosure is arranged at the first metallic enclosure, and an internal space is formed between the first metallic enclosure and the second metallic enclosure. The at least one metal assembly is disposed in the internal space. The at least one metal assembly is connected to the first metallic enclosure and the second metallic enclosure. The at least one metal assembly and the first metallic enclosure and the second metallic enclosure together form at least one metal cavity. Each of the at least one metal cavity has an opening opposite to the metal assembly. Each of the at least one antenna is disposed in the corresponding metal cavity and close to the opening. Each of the at least one antenna includes a grounded radiator, a radiator assembly, and a low frequency feed arm. The grounded radiator is conducted to the first metallic enclosure. The radiator assembly includes a feed end and a ground end. The ground end is connected to the grounded radiator. The low frequency feed arm is connected to the radiator assembly. The radiator assembly and the low frequency feed arm together resonate at a low frequency band and a first high frequency band, and the radiator assembly resonates at a second high frequency band.

Based on the above, a signal of the antenna can radiate through the opening, so that an influence on the antenna signal from the metallic enclosure and internal metal components thereof can be reduced, and an anti-interference capability of the antenna can be improved. In addition, the grounded radiator of the antenna is conducted to the first metallic enclosure, so that an advantage of low specific absorption rate of electromagnetic waves can be achieved. Furthermore, because the radiator assembly and the low frequency feed arm together resonate at the low frequency band and the first high frequency band, and the radiator assembly resonates at the second high frequency band, the antenna has a broadband characteristic.

### BRIEF DESCRIPTION OF THE DRAWINGS

FIG. 1 is a perspective schematic view of an electronic device according to an embodiment of the disclosure.

FIG. 2 is a partial sectional schematic view of the electronic device of FIG. 1.

FIG. 3 is a partial top schematic view of the electronic device of FIG. 1.

FIG. 4 is a schematic view of the antenna of the electronic device of FIG. 1.

FIG. 5 is a graph showing a relationship between frequency and voltage standing wave ratio of the antenna of FIG. 4.

FIG. 6 is a graph showing a relationship between frequency and antenna efficiency of the antenna of FIG. 4.

FIG. 7 is a graph showing a relationship between frequency and maximum antenna gain of the antenna of FIG. 4.

FIG. 8 is a partial schematic view of FIG. 1.

FIG. 9 is a partial schematic view of an electronic device according to another embodiment of the disclosure.

### DESCRIPTION OF THE EMBODIMENTS

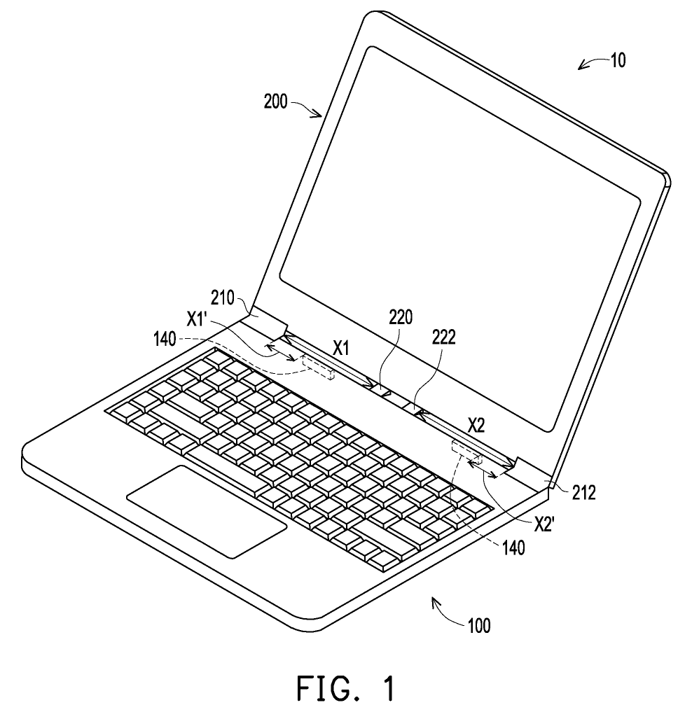

FIG. 1 is a perspective schematic view of an electronic device according to an embodiment of the disclosure. Please refer to FIG. 1. An electronic device 10 of this embodiment is, for example, a notebook computer. However, in other embodiments, the electronic device 10 may also be a tablet computer or a mobile phone. The type of the electronic device 10 is not limited thereto.

The electronic device 10 of this embodiment includes a first body 100 and a second body 200. The second body 200 is pivotally connected to the first body 100 through two pivots 210 and 212, and the second body 200 is electrically connected to the first body 100 through at least one of cables 220 and 222. The at least one of the cables 220 and 222 is located between the two pivots 210 and 212. In this embodiment, a number of the cables 220 and 222 is, for example, two. However, the number of the cables 220 and 222 is not limited thereto.

The first body 100 includes at least one antenna 140. In this embodiment, a number of the antennas 140 is two, but is not limited thereto. A left antenna 140 of FIG. 1 is disposed between a left cable 220 and a left pivot 210, and a right antenna 140 is disposed between a right cable 222 and a right pivot 212. That is, the two antennas 140 are separated by the two cables 220 and 222. Such a configuration allows the two antennas 140 to have a better isolation performance.

One of the antennas 140 and an environment surrounding the same will be described below. Another antenna 140 and an environment surrounding the same will be the same as or close to the description below and will not be described redundantly.

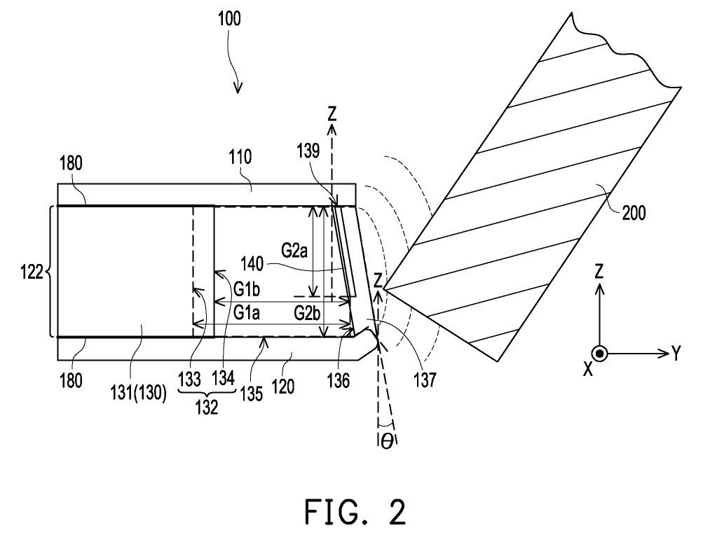

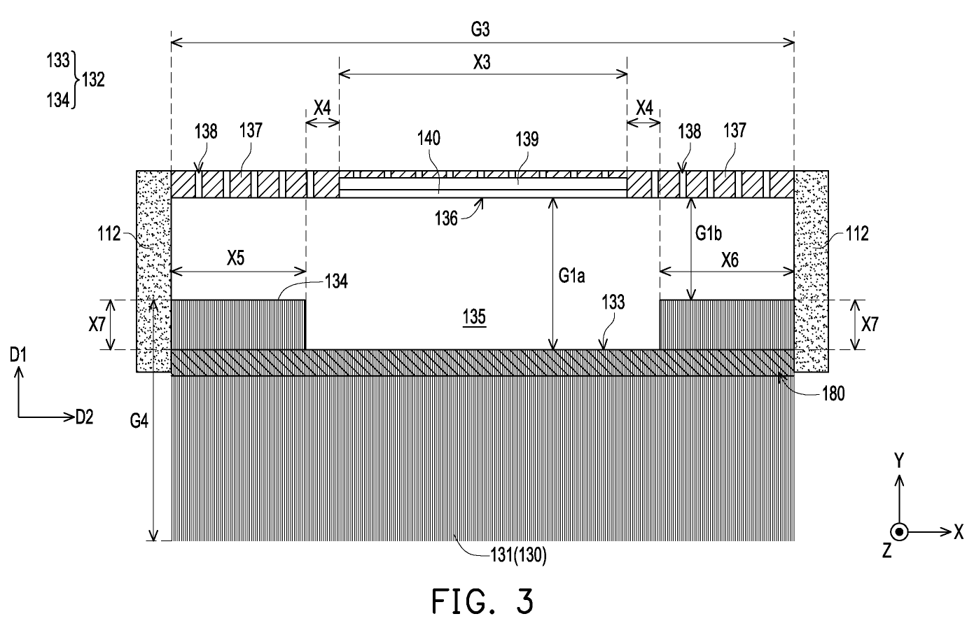

FIG. 2 is a partial sectional schematic view of the electronic device of FIG. 1. FIG. 3 is a partial top schematic view of the electronic device of FIG. 1. It is to be noted that FIG. 2 is a side view, and FIG. 3 is a top view. Two antennas 140 are shown in FIG. 1. FIGS. 2 and 3 merely illustrate different views of one of the antennas 140 and surrounding components thereof.

Please refer to FIGS. 2 and 3. The first body 100 includes a first metallic enclosure 110, a second metallic enclosure 120, a metal assembly 130, and the antenna 140. The second metallic enclosure 120 is arranged at the first metallic enclosure 110, and an internal space 122 is formed between the first metallic enclosure 110 and the second metallic enclosure 120.

The metal assembly 130 is disposed in the internal space 122. In this embodiment, the metal assembly 130 includes a plurality of heat dissipation fins 131, but a type of the metal assembly 130 is not limited thereto. The heat dissipation fins 131 are, for example, made of aluminum alloy material and have a larger surface area to increase a contact area with air. A spacing between two adjacent heat dissipation fins 131 is, for example, 1 millimeter, but is not limited thereto.

The metal assembly 130 is connected to and conducted to the first metallic enclosure 110 and the second metallic enclosure 120. As shown in FIG. 2, upper and lower surfaces of the heat dissipation fins 131 are attached to the first metallic enclosure 110 and the second metallic enclosure 120 respectively through a conductive foam 180.

In addition, as shown in FIG. 3, in this embodiment, two sides of the heat dissipation fins 131 of the metal assembly 130 are adjacent to two extended inner sidewalls 112 of a metal cavity 135. The two extended inner sidewalls 112 are, for example, extended from the first metallic enclosure 110.

The antenna 140 is attached to the first metallic enclosure 110 and the second metallic enclosure 120, so that an advantage of low specific absorption rate (low SAR) of electromagnetic waves can be achieved.

The metal assembly 130 and the first metallic enclosure 110 and the second metallic enclosure 120 together form a metal cavity 135. In one embodiment, dimensions of the metal cavity 135 are approximately 85 millimeters, 10.5 millimeters, and 6.7 millimeters, but are not limited thereto.

The metal cavity 135 has an opening 136 opposite to the metal assembly 130. The antenna 140 is disposed in the metal cavity 135 and close to the opening 136. The antenna 140 radiates through the opening 136, so that an influence on a signal of the antenna from the metallic enclosure and internal metal components thereof can be reduced, and an anti-interference capability of the antenna 140 can be improved.

The opening 136 is provided with a non-conductive member 137 including heat dissipation holes 138 (FIG. 3). An airflow generated by a fan (not shown) in the first body 100 passes through a gap between the heat dissipation fins 131 of the metal assembly 130 and exits the first body 100 through the heat dissipation holes 138, so that a good heat dissipation effect can be provided for the electronic device 10.

In this embodiment, the antenna 140 is disposed on a substrate 139. The substrate 139 is disposed on the non-conductive member 137. As shown in FIG. 3, in this embodiment, a length X3 of the substrate 139 is approximately 40 millimeters, and a distance X4 between two sides of the substrate 139 and a peripheral region 134 is approximately 5 millimeters.

In addition, the metal assembly 130 includes a side edge 132 facing the opening 136. A distance between the side edge 132 and the opening 136 is greater than or equal to 5 millimeters. In this embodiment, the side edge 132 includes a central region 133 corresponding to the antenna 140 and a peripheral region 134 surrounding the central region 133. A length of the central region 133 is a sum of X3 and two times X4, which is approximately 50 millimeters. A length X5 of a left peripheral region 134 in FIG. 3 is approximately 12.5 millimeters. A length X6 of a right peripheral region 134 in FIG. 3 is approximately 19 millimeters, but is not limited thereto.

A distance G1a between the central region 133 and the opening 136 is greater than or equal to a distance G1b between the peripheral region 134 and the opening 136. In this embodiment, the distance G1b is approximately equal to 5 millimeters, and a distance X7 is 1.7 millimeters. The distance G1a is a sum of the distance G1b and the distance X7. Such a design allows the central region 133 to be farther from the opening 136, so that more antenna clearance space is reserved. The peripheral region 134 is closer to the opening 136, so that the heat dissipation fins 131 are longer and can have better heat dissipation effect. Of course, in one embodiment, the distance G1a may also be equal to the distance G1b.

In addition, as shown in FIG. 2, a distance G2a is a distance between a farthest portion of the antenna 140 away from the first metallic enclosure 110 and the first metallic enclosure 110 (for example, 6 to 7 millimeters), and a distance G2b is a distance between the first metallic enclosure 110 and the second metallic enclosure 120 (for example, 10.5 millimeters). A distance between the antenna 140 and the second metallic enclosure 120, that is, G2b - G2a, is 3.5 to 4.5 millimeters. When the antenna 140 is closer to the second metallic enclosure 120, a lower specific absorption rate of electromagnetic waves can be maintained, and a lower SAR back-off power mode can be achieved. In other words, OTA performance of the antenna 140 can be improved.

Further, as shown in FIG. 2, an inclination angle θ of the non-conductive member 137 that covers the opening 136 relative to a Z axis may be greater than or equal to 0 degrees, so as to match an appearance change angle range.

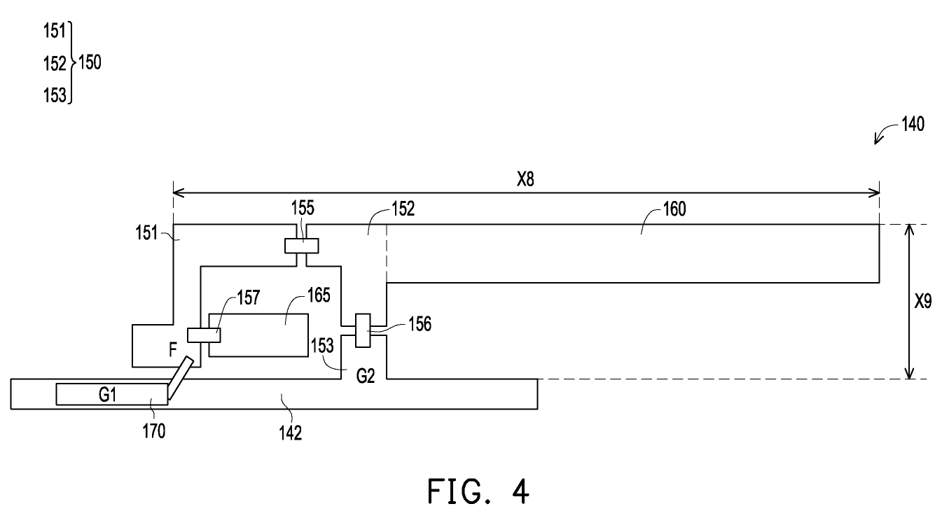

FIG. 4 is a schematic view of the antenna of the electronic device of FIG. 1. Please refer to FIG. 4. The antenna 140 includes a grounded radiator 142, a radiator assembly 150, and a low frequency feed arm 160. A length X8 of the radiator assembly 150 and the low frequency feed arm 160 is 25 millimeters, and a width X9 is 5 millimeters.

The grounded radiator 142 is conducted to the first metallic enclosure 110. In this embodiment, the radiator assembly 150 includes a first radiator 151, a second radiator 152, and a third radiator 153.

The first radiator 151 includes a feed end F. A positive terminal of a coaxial transmission line 170 is connected to the feed end F, and a negative terminal of the coaxial transmission line 170 is connected to the grounded radiator 142 through a ground end G1. The grounded radiator 142 is connected to the first metallic enclosure 110 to perform system grounding.

The first radiator 151 and the second radiator 152 are connected through a first electronic element 155. The second radiator 152 and the third radiator 153 are connected through a second electronic element 156. The third radiator 153 includes a ground end G2. The ground end G2 of the third radiator 153 is connected to the grounded radiator 142.

The low frequency feed arm 160 is connected to the second radiator 152 of the radiator assembly 150. The radiator assembly 150 and the low frequency feed arm 160 together resonate at a low frequency band and a first high frequency band, and the radiator assembly 150 resonates at a second high frequency band.

In this embodiment, each of the first electronic element 155 and the second electronic element 156 is an inductor between 0.5nH and 1.5nH. The first electronic element 155 is, for example, 1.0nH, and the second electronic element 156 is, for example, 0.7nH, but is not limited thereto. The first electronic element 155 can adjust impedance matching of the low frequency band and the first high frequency band. The second electronic element 156 can adjust impedance matching of the second high frequency band.

In addition, the antenna 140 further includes a high frequency feed arm 165 connected to the feed end F through a third electronic element 157. The radiator assembly 150 and the high frequency feed arm 165 together resonate at a third high frequency band. The third electronic element 157 is a resistor between 10 ohms and 20 ohms, for example, 15 ohms. A length of the high frequency feed arm 165 can adjust impedance matching of the third high frequency band. The third electronic element 157 can effectively reduce a peak gain of the antenna 140 to avoid excessive directivity.

In this embodiment, the low frequency band is between 2400MHz and 2500MHz, the first high frequency band and the second high frequency band together are between 5925MHz and 7125MHz, and the third high frequency band is between 5150MHz and 5850MHz. Therefore, the antenna 140 is a Wi-Fi 6E/7 broadband antenna 140, and can support the low frequency band (2400MHz to 2500MHz) and the high frequency band (5150MHz to 7125MHz).

Please return to FIG. 3. The heat dissipation fins 131 extend toward the opening 136 along a first direction D1, and a length G4 of a portion of the heat dissipation fins 131 in the first direction D1 positioned outside the antenna 140 is between 0.15 times and 0.2 times a wavelength of the low frequency band. Specifically, the length G4 is 21 millimeters (approximately 0.16 times to 0.17 times a wavelength of the low frequency band).

In addition, the heat dissipation fins 131 are arranged along a second direction D2. A length G3 of each of the metal cavities 135 in the second direction D2 is between 0.65 times and 0.7 times a wavelength of the low frequency band.

Please return to FIG. 1. Distances X1 and X2 between each of the two cables 220 and 222 and the corresponding pivots 210 and 212 are greater than or equal to 0.8 times a wavelength of the low frequency band. Specifically, in this embodiment, the distance X1 between the left cable 220 and the left pivot 210 of FIG. 1 is approximately 0.8 to 1.2 times a wavelength of the low frequency band, which is approximately 128 millimeters. The distance X2 between the right cable 222 and the right pivot 212 of FIG. 1 is approximately 0.8 to 0.9 times a wavelength of the low frequency band, which is approximately 105 millimeters.

In addition, each of a distance X1’ between the left antenna 140 and the left pivot 210 and a distance X2’ between the right antenna 140 and the right pivot 212 is 0.15 to 0.25 times a wavelength of the low frequency band. In the embodiment, the distance is 22.5 millimeters.

Such a design allows sufficient space around the antenna 140, so that the antenna 140 can have good performance.

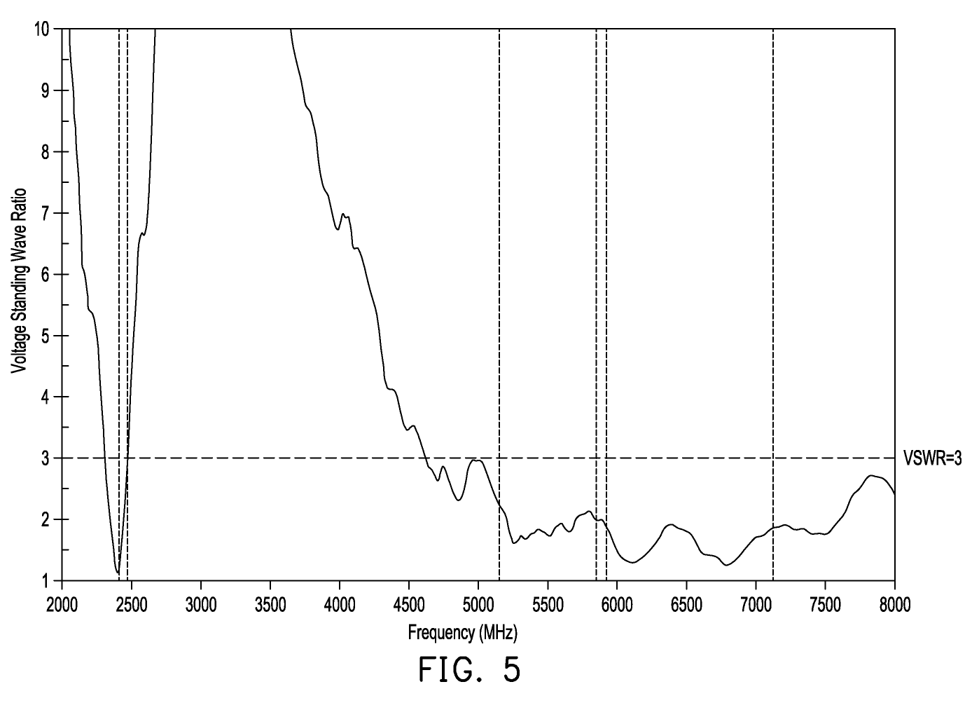

FIG. 5 is a graph showing a relationship between frequency and voltage standing wave ratio of the antenna of FIG. 4. Please refer to FIG. 5. Within the low frequency band (2400MHz to 2500MHz) and the high frequency band (5150MHz to 7125MHz), a VSWR of the antenna 140 can be less than 3, and good performance can be provided.

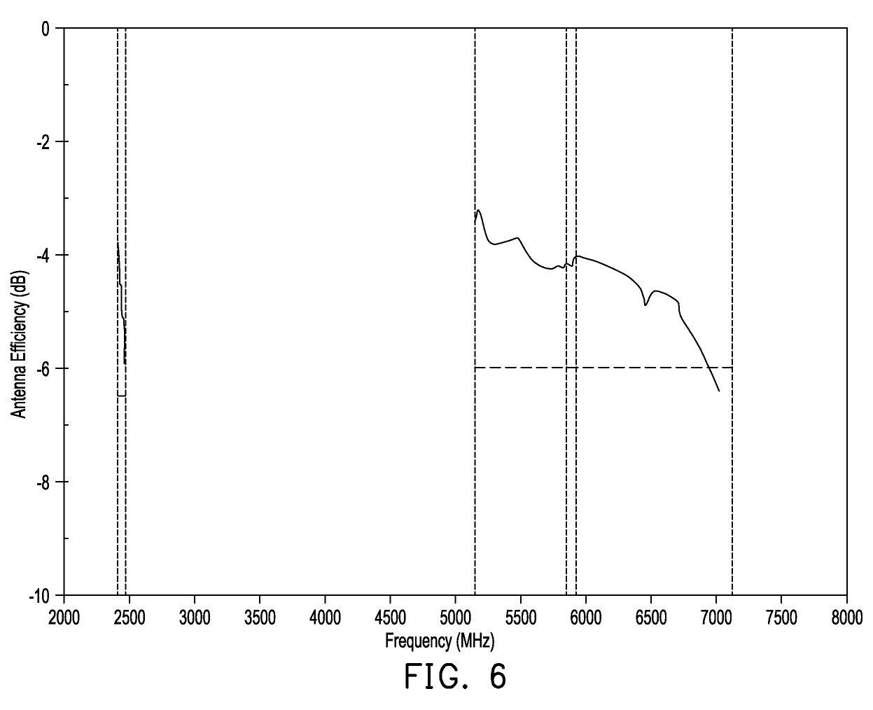

FIG. 6 is a graph showing a relationship between frequency and antenna efficiency of the antenna of FIG. 4. Please refer to FIG. 6. An antenna efficiency of the antenna 140 within the low frequency band (2400MHz to 2500MHz) is -3.8 to -5.9 dB, and an antenna efficiency within the high frequency band (5150MHz to 7125MHz) is -3.2 to -6.4 dB, and good performance can be provided. Therefore, the antenna 140 can have characteristics of broadband and good antenna efficiency.

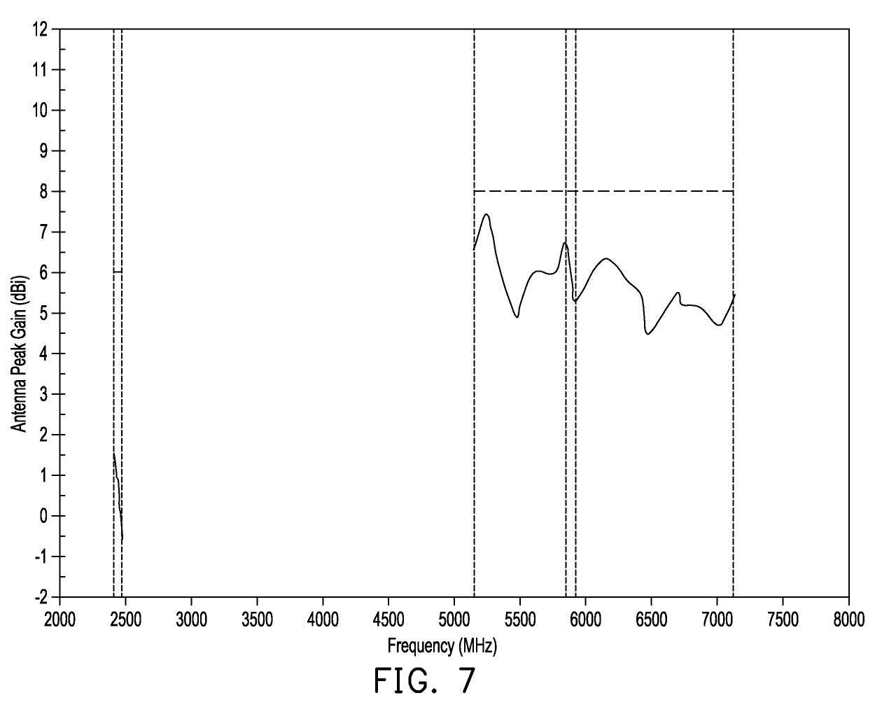

FIG. 7 is a graph showing a relationship between frequency and maximum antenna gain of the antenna of FIG. 4. Please refer to FIG. 7. A maximum antenna gain of the antenna 140 within the low frequency band (2400MHz to 2500MHz) is less than 6 dBi, and a maximum antenna gain within the high frequency band (5150MHz to7125MHz) is less than 8 dBi, and good performance can be provided.

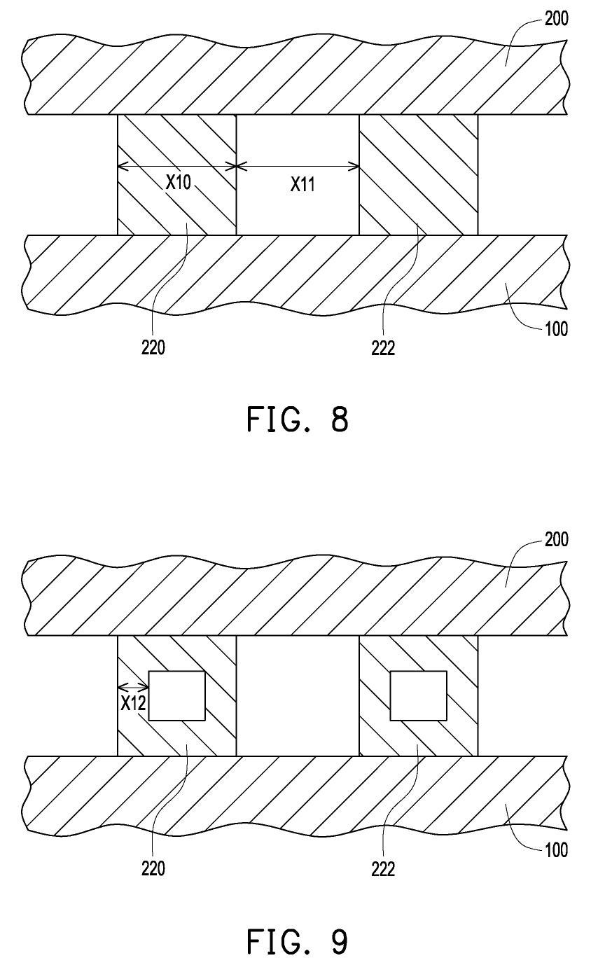

FIG. 8 is a partial schematic view of FIG. 1. Please refer to FIG. 8. In this embodiment, a width X10 of each of the cables 220 and 222 is approximately 19 millimeters, and a distance X11 between the two cables 220 and 222 is approximately 5 millimeters. The cables 220 and 222 have at least one ground plane (not shown). The ground planes of the cables 220 and 222 are attached to a metallic enclosure of the second body 200 and to the first metallic enclosure 110 and the second metallic enclosure 120 of the first body 100. In one embodiment, the cables 220 and 222 may have three metal layers. An upper layer and a lower layer are two ground planes, and a middle layer is a signal line layer. The signal line layer is surrounded by the upper and lower ground planes to prevent a signal transmitted through the cables from affecting a signal of the antenna, and to increase isolation between the two antennas 140, but a structure of the cables 220 and 222 is not limited thereto.

FIG. 9 is a partial schematic view of an electronic device according to another embodiment of the disclosure. Please refer to FIG. 9. To reduce a risk that the cables 220 and 222 are pulled and damaged when the second body 200 is opened and closed, the cables 220 and 222 are formed in a rectangular shape, that is, with a hole in the center, so as to increase a deformable degree of the cables 220 and 222. A width X12 of the cables 220 and 222 is approximately 1 millimeter, but is not limited thereto.

In this embodiment, the cables 220 and 222 may have two metal layers. One layer is a ground layer, and another one layer is a signal layer. A ground wire outside a routing of the signal layer can be exposed and attached to the second body 200 to increase isolation between the two antennas 140.

In summary, the metal assembly of the electronic device of the disclosure and the first metallic enclosure and the second metallic enclosure together form a metal cavity. The metal cavity has an opening opposite to the metal assembly. The antenna is disposed in the metal cavity and close to the opening. A signal of the antenna can be radiated through the opening, so that an influence on the antenna signal from the metallic enclosure and internal metal components thereof can be reduced, and an anti-interference capability of the antenna can be improved. In addition, the grounded radiator of the antenna is conducted to the first metallic enclosure, so that an advantage of low specific absorption rate of electromagnetic waves can be provided. Furthermore, a ground end of the radiator assembly of the antenna is connected to the grounded radiator, and the low frequency feed arm is connected to the radiator assembly. The radiator assembly and the low frequency feed arm together resonate at a low frequency band and a first high frequency band, and the radiator assembly resonates at a second high frequency band, so that a broadband characteristic can be provided.

What is claimed is:

1. An electronic device, comprising:
a first body, comprising:
a first metallic enclosure;
a second metallic enclosure, arranged at the first metallic enclosure, wherein an internal space is formed between the first metallic enclosure and the second metallic enclosure;
at least one metal assembly, disposed in the internal space, wherein the at least one metal assembly is connected to the first metallic enclosure and the second metallic enclosure, each of the at least one metal assembly and the first metallic enclosure and the second metallic enclosure together form a metal cavity, and the metal cavity has an opening opposite to the metal assembly; and
at least one antenna, wherein each of the at least one antenna is disposed in the corresponding metal cavity and close to the opening, and each of the at least one antenna comprises:
a grounded radiator, conducted to the first metallic enclosure;
a radiator assembly, comprising a feed end and a ground end, wherein the ground end is connected to the grounded radiator; and
a low frequency feed arm, connected to the radiator assembly, wherein the radiator assembly and the low frequency feed arm together resonate at a low frequency band and a first high frequency band, and the radiator assembly resonates at a second high frequency band.

2. The electronic device according to claim 1, wherein each of the at least one metal assembly comprises a side edge facing the opening, and a distance between the side edge and the opening is greater than or equal to 5 millimeters.

3. The electronic device according to claim 2, wherein the side edge comprises a central region corresponding to the antenna and a peripheral region surrounding the central region, and a distance between the central region and the opening is greater than or equal to a distance between the peripheral region and the opening.

4. The electronic device according to claim 1, wherein each of the at least one metal assembly comprises a plurality of heat dissipation fins, and the opening is provided with a non-conductive member comprising a heat dissipation hole.

5. The electronic device according to claim 4, wherein the plurality of heat dissipation fins extend toward the opening along a first direction, and a length of at least a portion of the plurality of heat dissipation fins positioned outside the antenna in the first direction is between 0.15 times and 0.2 times a wavelength of the low frequency band.

6. The electronic device according to claim 4, wherein the plurality of heat dissipation fins are arranged along a second direction, and a length of each of the at least one metal cavity in the second direction is between 0.65 times and 0.7 times a wavelength of the low frequency band.

7. The electronic device according to claim 1, further comprising:
a second body, pivotally connected to the first body through two pivots and electrically connected to the first body through at least one cable, wherein the at least one antenna comprises two antennas, one of the two antennas is disposed between the at least one cable and one of the two pivots, and another one of the two antennas is disposed between the at least one cable and another one of the two pivots.

8. The electronic device according to claim 7, wherein a distance between the at least one cable and each of the pivots is greater than or equal to 0.8 times a wavelength of the low frequency band.

9. The electronic device according to claim 7, wherein a distance between each of the antennas and an adjacent one of the pivots is 0.25 times a wavelength of the low frequency band.

10. The electronic device according to claim 1, wherein the radiator assembly comprises a first radiator, a second radiator, and a third radiator, the first radiator comprises the feed end, the third radiator comprises the ground end, the first radiator and the second radiator are connected through a first electronic element, and the second radiator and the third radiator are connected through a second electronic element.

11. The electronic device according to claim 10, wherein each of the first electronic element and the second electronic element is an inductor between 0.5nH and 1.5nH.

12. The electronic device according to claim 10, wherein the low frequency feed arm is connected to the second radiator.

13. The electronic device according to claim 1, wherein each of the at least one antenna further comprises a high frequency feed arm connected to the feed end through a third electronic element, and the radiator assembly and the high frequency feed arm together resonate at a third high frequency band.

14. The electronic device according to claim 13, wherein the third electronic element is a resistor between 10 ohms and 20 ohms.

15. The electronic device according to claim 13, wherein the low frequency band is between 2400MHz and 2500MHz, the first high frequency band and the second high frequency band are both between 5925MHz and 7125MHz, and the third high frequency band is between 5150MHz and 5850MHz.
